(19) United States
(12) Patent Application Publication
(10) Pub. No.: US 2022/0048344 A1
(43) Pub. Date: Feb. 17, 2022

(54) POSITION AND DRAFT CONTROL MECHANISM FOR AN IMPLEMENT COUPLED TO VEHICLE HITCH

(71) Applicant: MAHINDRA & MAHINDRA LIMITED, Mohali (IN)

(72) Inventor: Vikas Singh, Mohali (IN)

(21) Appl. No.: 17/275,370

(22) PCT Filed: Sep. 12, 2019
(86) PCT No.: PCT/IN2019/050666

§ 371 Date: Mar. 11, 2021

(30) Foreign Application Priority Data
Sep. 12, 2018 (IN) 201811034474

(51) Int. Cl. B60D 1/36

(52) U.S. Cl. CPC B60D 1/36

(57) ABSTRACT

Position and draft control mechanism (30) for an implement coupled to vehicle hitch (50) is provided. Position and draft control mechanism (30) includes a position control mechanism (300) and a draft control mechanism (400). The position control mechanism (300) includes a position control lever assembly (302), a locking arrangement (304), a linkage mechanism (306), a locking member position control mechanism and a resilient member (304R). The draft control mechanism (400) includes a sliding assembly (402), a first end cover (404), a housing (406), a second end cover (407), a resilient and shock absorber arrangement 408 and an adjustable assembly (410). A movement of position control lever assembly (302) induces a change in position of the implement. The locking arrangement (304) is adapted to lock position control lever assembly (302) at at least one of a plurality of positions. The draft control mechanism (400) is adapted to vary draft of implement coupled to an implement mounting structure (50) of vehicle.

### CROSS REFERENCE TO RELATED APPLICATION

This application is based on and derives the benefit of Indian Application 201811034474 filed on 12 Sep. 2018, the contents of which are incorporated herein by reference.

### TECHNICAL FIELD

The embodiments herein relate to a position and draft control mechanism for an agricultural implement coupled to an implement mounting structure (hitch) of a vehicle.

### BACKGROUND

Vehicles such as tractors and other similar vehicles are primarily used in agricultural field operations. One of the most common uses of agricultural tractors is to move an agricultural implement through agricultural fields to condition the soil for cultivation. Usually, the agricultural implements are attached to a rear-end and/or a front-end of the vehicle using a hitch or a drawbar depending on the type of vehicle configuration and the type of field operation (work) that is to be carried out in the agricultural fields. Position and draft control mechanism of the vehicle is used for controlling the position (raising and lowering) of the agricultural implement, and for controlling the draft of the agricultural implement to regulate corresponding depth operation of the agricultural implement in agricultural fields. Most of the agricultural implements are heavy weight implements which attains desired depth of operation by their own weight. However, the heavy weight implements are difficult to handle in the agricultural fields, increases an overall weight of the vehicle and incurs high cost due to the heavy weight of the agricultural implement. On the other hand, light weight implements are easy to handle and cost effective. However, light weight implements cannot attain desired depth of operation in agricultural fields due to the light weight of the agricultural implement. The agricultural implements are subjected to shock loads when the agricultural implement is towed by the vehicle in agricultural fields. The shock loads received by the agricultural implement is undesirable. Hence, there is a requirement to absorb the shock loads received by the implement to restrict wear and tear of the components in position and draft mechanism to prevent the failure of the system.

Conventional electro-hydraulic position and draft control mechanism enables precise adjustment in position and draft of the agricultural implement. However, the electro-hydraulic position and draft control mechanism is complex in design and incurs high cost.

Therefore, there exists a need for a position and draft control mechanism for an agricultural implement coupled to an implement mounting structure (hitch) of a vehicle, which obviates the aforementioned drawbacks.

### OBJECTS

The principal object of an embodiment of this invention is to provide a position and draft control mechanism for an agricultural implement coupled to a implement mounting structure (hitch) of a vehicle, which is used to control the position (raising and lowering) of the agricultural implement, and to vary the draft of the agricultural implement, and to dampen a shock load received by the agricultural implement.

Another object of an embodiment of this invention is to provide a position control mechanism for controlling the position (raising and lowering) of an agricultural implement coupled to an implement mounting structure (hitch) of a vehicle.

Another object of an embodiment of this invention is to provide a draft control mechanism for an agricultural implement coupled to an implement mounting structure (hitch) of a vehicle, which varies the draft of the agricultural implement in accordance to various types of implements and various types of agricultural field operations.

Another object of an embodiment of this invention is to provide a position control mechanism for an agricultural implement coupled to an implement mounting structure (hitch) of a vehicle, which comprises a locking arrangement for locking a position of the agricultural implement.

Yet, another object of an embodiment of this invention is to provide a draft control mechanism for an agricultural implement coupled to an implement mounting structure (hitch) of a vehicle, which comprises a resilient and shock absorber arrangement adapted to dampen a shock load received by the agricultural implement.

A further object of an embodiment of this invention is to provide a draft control mechanism for controlling the draft of alight weight agricultural implement coupled to an implement mounting structure (hitch) of a vehicle, which enables the attached light weight agricultural implement to attain desired depth operation in agricultural fields.

These and other objects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments of the invention are illustrated in the accompanying drawings, throughout which like reference letters indicate corresponding parts in the various figures. The embodiments herein will be better understood from the following description with reference to the drawings, in which:

FIG. 1 depicts a perspective view of a position and draft control mechanism for an agricultural implement coupled to an implement mounting structure (hitch) of a vehicle, according to an embodiment of the invention as disclosed herein;

FIG. 2 depicts a perspective view of a position control lever support member of the position control lever assembly, according to an embodiment of the invention as disclosed herein;

FIG. 3 depicts a perspective view of a first locking element of a locking arrangement, according to an embodiment of the invention as disclosed herein;

FIG. 4 depicts a perspective view of a second locking element of the locking arrangement, according to an embodiment of the invention as disclosed herein;

FIG. 5 depicts an exploded view of a draft control mechanism, according to an embodiment of the invention as disclosed herein; and

FIG. 6 depicts a cross-sectional view of the draft control mechanism, according to an embodiment of the invention as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

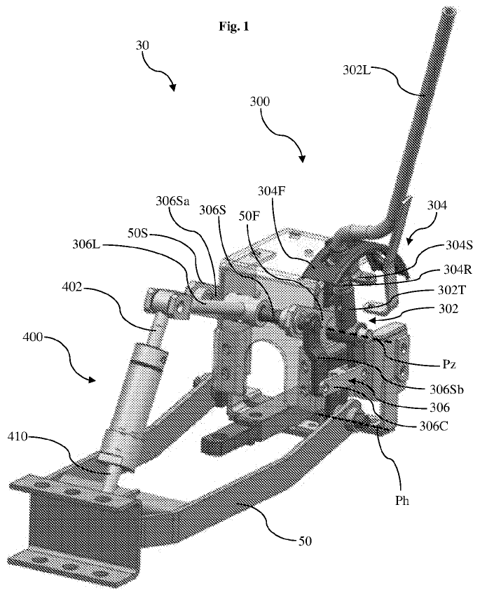

The embodiments herein achieve a position and draft control mechanism for an agricultural implement coupled to an implement mounting structure (hitch) of a vehicle, which is used to control the position (raising and lowering) of the agricultural implement, and to vary the draft of the agricultural implement, and to dampen a shock load received by the agricultural implement. Referring now to the drawings, and more particularly to FIGS. 1 through 6, where similar reference characters denote corresponding features consistently throughout the figures, there are shown embodiments.

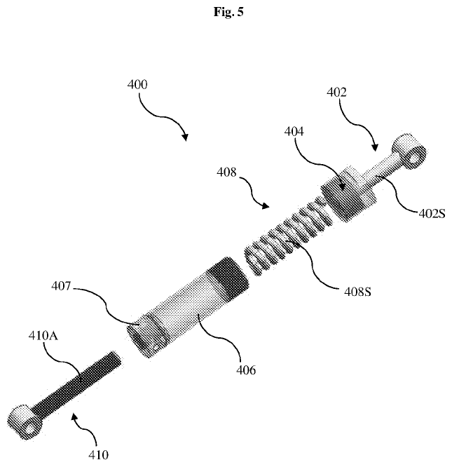

FIG. 1 depicts a perspective view of a position and draft control mechanism 30 for an agricultural implement coupled to an implement mounting structure 50 (hitch) of a vehicle, according to an embodiment of the invention as disclosed herein. FIG. 5 depicts an exploded view of a draft control mechanism 400, according to an embodiment of the invention as disclosed herein. In an embodiment, the vehicle (not shown) includes a position and draft control mechanism 30, an implement mounting structure 50, a first support structure 50F, a second support structure 50S and may include other standard components, mechanisms and systems as present in a standard vehicle. The position and draft control mechanism 30 is used to control the position (raising and lowering) of an agricultural implement (hereinafter called as implement), and to vary the draft of implement, and to dampen a shock load received by the implement. In an embodiment, the position and draft control mechanism 30 includes a position control mechanism 300 and a draft control mechanism 400. In an embodiment, the position control mechanism 300 includes a position control lever assembly 302, a locking arrangement 304, a linkage mechanism 306, a locking member position control mechanism (not shown) and at least one resilient member 304R. In an embodiment, the draft control mechanism 400 comprises a sliding assembly 402, a first end cover 404, at least one housing 406, a second end cover 407, at least one resilient and shock absorber arrangement 408 and an adjustable assembly 410. For the purpose of this description and ease of understanding, the position and draft control mechanism 30 is explained herein below with reference to be provided in an agricultural vehicle. However, it is also within the scope of the invention to implement/practice the position and draft control mechanism 30 in an off-road vehicle, an agricultural harvester and/or any other type of vehicle without otherwise deterring the intended function of the position and draft control mechanism 30 as can be deduced from the description and corresponding drawings.

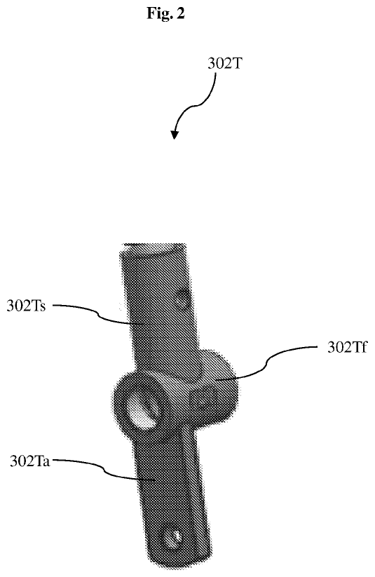

FIG. 2 depicts a perspective view of a position control lever support member 302T of the position control lever assembly 302, according to an embodiment of the invention as disclosed herein. The position control lever assembly 302 is used to control the position (raising and lowering) of the implement, and to maintain the draft force provided to the implement (not shown) at the adjusted position therein to provide constant draft force to the implement. The position control lever assembly 302 is pivotably connected to the first support structure 50F about a position control lever pivot axis Pz (as shown in FIG. 1). A movement of the position control lever assembly 302 induces a change in the position of the implement. In an embodiment, the position control lever assembly 302 includes a position control lever support member 302T and a position control lever 302L. The position control lever support member 302T is used to support the position control lever 302L and is pivotably connected to the first support structure 50F. The position control lever support member 302T includes a first portion 302Tf, a second portion 302Ts and at least one arm 302Ta. The first portion 302Tf of the position control lever support member 302T is pivotably connected to the first support structure 50F about the position control lever pivot axis Pz thereby pivotably connecting the position control lever assembly 302 to the first support structure 50F about the position control lever pivot axis Pz. The second portion 302Ts of the position control lever support member 302T is transversely extending from the first portion 302Tf in an upward direction towards the position control lever 302L. The second portion 302Ts of the position control lever support member 302T is used to support the position control lever 302L. The arm 302Ta of the position control lever support member 302T is transversely extending from the first portion 302Tf in a downward direction towards corresponding end of a coupler 306C (as shown in FIG. 1) of the linkage mechanism 306. The arm 302Ta of the position control lever support member 302 is coupled with corresponding end of the coupler 306C therein to couple the position control lever assembly 302 with the coupler 306C of the linkage mechanism 306.

The position control lever 302L is supported by the position control lever support member 302T. The position control lever 302L is pivotably connected to the first support structure 50F through the position control lever support member 302T. One end of the position control lever 302L is connected to the position control lever support member 302T and another end of the position control lever 302L is engaged by an operator to alter the position of the position control lever assembly 302 to change the position of the implement. It is also within the scope of the invention to integrate the position control lever 302L and the position control lever support member 302T as a single part to form the position control lever assembly 302.

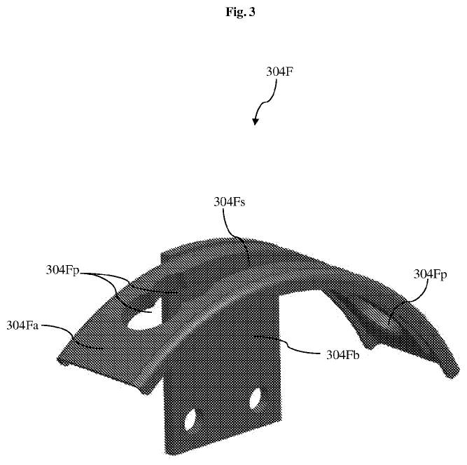

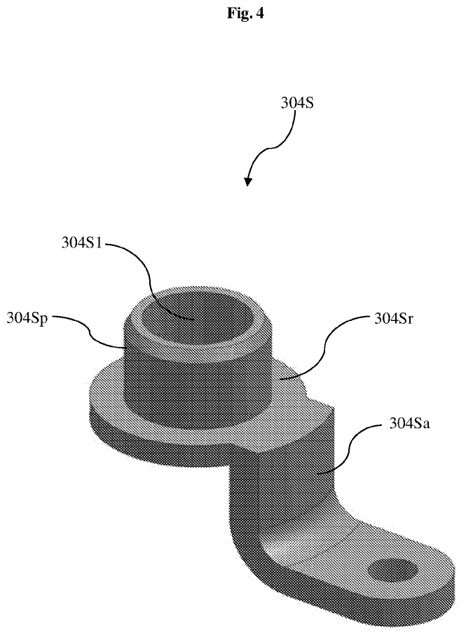

FIG. 3 depicts a perspective view of a first locking element 304F of a locking arrangement 304, according to an embodiment of the invention as disclosed herein. In an embodiment, the locking arrangement 304 is adapted to lock the position control lever assembly 302 at at least one of a plurality of positions therein to lock the implement at corresponding at least one of a plurality of positions. The plurality of positions to which the implement is to be positioned and locked, includes at least one lowered position and at least one raised position. In an embodiment, the locking arrangement 304 includes a first locking element 304F and a second locking element 304S. The first locking element 304F is supported by the first support structure 50F. The first locking element 304F includes a first portion 304Fa and a second portion 304Fb. The first portion 304Fa of the first locking element 304F defines a slot 304Fs and a plurality of locking portions 304Fp. The slot 304Fs of the first portion 304Fa of the first locking element 304F is used to allow the angular movement of the position control lever 302L of the position control lever assembly 302. The slot 304Fs of the first portion 304Fa of the first locking element 304F substantially defines an arcuate slot shape configuration. The plurality of locking portions 304Fp of the first portion 304F of the first locking element 304F are provided in the slot 304Fs at corresponding locking positions, where each locking position at which the position control lever assembly 302 assembly is to be locked with the first locking element 304F corresponds with corresponding each locking portion 304Fp of the first portion 304Fa of the first locking element 304F. At least one of the plurality of locking portions 304Fp of the first portion 304Fa of the first locking element 304F is selectively engaged by corresponding locking portion 304Sp (as shown in FIG. 4) of the second locking element 304S to lock the position control lever assembly 302 at corresponding at least one of the positions therein to lock the implement at corresponding at least one of the positions. Each locking portion 304Fp of the first portion 304Fa of the first locking element 304F is at least a notch. It is also within the scope of the invention to provide any other opening or any other locking portion in the slot 304Fs of the first portion 304Fa of the first locking element 304F, and the second locking element 304S is provided with corresponding formation of protrusion or any other corresponding locking portion for enabling engagement of the second locking element 304S with the first locking element 304F for locking the position control lever assembly 302 at at least one of the plurality of positions. The first portion 304Fa of the first locking element 304F substantially defines an arcuate shape configuration. The second portion 304Fb of the first locking element 304F is removably connected to the first support structure 50F thereby connecting the first locking element 304F to the first support structure 50F. One end of the second portion 304Fb of the first locking element 304F is connected to the first portion 304Fa of the first locking element 304F, and another end of the second portion 304Fb of the first locking element 304F is removably connected to the first support structure 50F.

FIG. 4 depicts a perspective view of a second locking element 304S of the locking arrangement 304, according to an embodiment of the invention as disclosed herein. In an embodiment, the second locking element 304S is used to lock the position control lever 302L of the position control lever assembly 302 with the first locking element 304F at at least one of the plurality of positions thereby locking the implement at corresponding at least one of the plurality of positions. The second locking element 304S is movably engaged (slidably engaged) with the first locking element 304F and the position control lever 302L of the position control lever assembly 302. The second locking element 304S is movable between an unlocked position in which the position control lever assembly 302 is unlocked from the first locking element 304F, and a locked position in which the position control lever assembly 302 is locked with the first locking element 304F at at least one of a plurality of locking positions thereby locking the implement at corresponding at least one of the plurality of positions. The second locking element 304S of the locking arrangement 304 has at least one locking portion 304Sp corresponding to the locking portion 304Fp of the first portion 304Fa of the first locking element 304F. The locking portion 304Sp of the second locking element 304S is disengaged from corresponding at least one locking portion 304Fp of the first locking element 304F to unlock the position control lever assembly 302 from the first locking element 304F on movement of the second locking element 304S to the unlocked position. The locking portion 304Sp of the second locking element 304S is engaged with at least one of the plurality of locking portions 304Fp of the first portion 304Fa of the first locking element 304F to lock the position control lever assembly 302 to the first locking element 304F at at least one of the plurality of locking positions thereby locking the implement at corresponding at least one of the plurality of positions on movement of the second locking element 304S to the locked position. The second locking element 304S has a supporting portion 304Sr and at least one arm 304Sa. The locking portion 304Sp of the second locking element 304S defines a lever receiving portion 30651 adapted to receive corresponding portion of the position control lever 302L therethrough to enable sliding movement of the second locking element 304S with the position control lever 302L when the second locking element 304S is moved between the unlocked position and the locked position. The lever receiving portion 30651 of the locking portion 304Sp of the second locking element 304S is at least a vertical opening. The supporting portion 304Sr of the second locking element 304S is radially extending from the locking portion 304Sp in an outward direction along the circumference of the locking portion 304Sp of the second locking element 304S. The supporting portion 304Sr of the second locking element 304S is used for supporting corresponding end of the resilient member 304R. The supporting portion 304Sr of the second locking element 304S is adapted to dis-engage from a bottom portion of the first portion 304Fa of the first locking element 304F to unlock the position control lever assembly 302 from the first locking element 304F on movement of the second locking element 304S to the unlocked position. The supporting portion 304Sr of the second locking element 304S is adapted to engage the bottom portion of the first portion 304Fa of the first locking element 304F at corresponding at least one of the plurality of locking positions to lock the position control lever assembly 302 with the first locking element 304F at corresponding at least one of the plurality of locking positions on movement of the second locking element 304S to locked position. The arm 304Sa of the second locking element 304S is used for connecting the second locking element 304S with a cable (not shown) of the locking member position control mechanism (not shown) to enable movement of the second locking element 304S between the unlocked position and the locked position. The arm 304Sa of the second locking element 304S substantially defines a L-shape configuration.

In an embodiment, the linkage mechanism 306 is used to couple the position control lever assembly 302 with the implement mounting structure 50 though the draft control mechanism 400. In an embodiment, the linkage mechanism 306 includes a coupler 306C, a cross-shaft assembly 306S and a lift arm 306L.

The coupler 306C of the linkage mechanism 306 is used for coupling the position control lever assembly 302 with a linkage element 306Sb of the cross-shaft assembly 306S. The coupler 306C is coupled between the position control lever support member 302T of the position control lever assembly 302 and the linkage element 306S of the cross-shaft assembly 306S. One end of the coupler 306C is coupled with the arm 302Ta of the position control lever support member 302T of the position control lever assembly 302, and another end of the coupler 306C is coupled with the linkage element 306Sb of the cross-shaft assembly 306S.

The cross-shaft assembly 306S is also called as rockshaft assembly. The cross-shaft assembly 306S of the linkage mechanism 306 includes a cross-shaft 306Sa and a linkage element 306Sb. The cross-shaft 306Sa is movably supported between the first support structure 50F and the second support structure 50S along the widthwise direction of the vehicle. The cross-shaft 306Sa is also called as rockshaft. The linkage element 306Sb is also called as cross-shaft turn link. One end of the linkage element 306Sb is connected to the cross-shaft 306Sa and another end of the linkage element 306Sb is connected to the coupler 306C.

The lift arm 306L of the linkage mechanism 306 is used for lifting and lowering the implement through the draft control mechanism 400 and the implement mounting structure 50. One end of the lift arm 306L is connected to the cross-shaft 306Sa of the cross-shaft assembly 306S and another end of the lift arm 306L is connected to the sliding assembly 402 of the draft control mechanism 400.

The locking member position control mechanism (not shown) is adapted to control the movement of the second locking element 304S between the unlocked position and the locked position. The locking member position control mechanism is at least a hand operated locking member position control mechanism. In an embodiment, the hand operated locking member position control mechanism (not shown) includes a hand operated control lever (not shown) and a cable (not shown). The hand operated control lever (not shown) is adapted to be connected to position control lever 302L of the position control lever assembly 302. The cable (not shown) is adapted to be connected between the hand operated control lever (not shown) and the arm 304Sa of the second locking element 304S. The cable (not shown) is adapted to move the second locking element 304S from the locked position to the unlocked position on engagement of the hand operated control lever (not shown).

The resilient member 304R is used to enable slidable movement of the second locking element 304S with the position control lever 302L between the unlocked position and the locked position. The resilient member 304R is loaded between the supporting portion 304Sr of the second locking element 304S and the second portion 302Ts of the position control lever support member 302T of the position control lever assembly 302. The resilient member 304R is movable between the retracted position (compressed position) in which the second locking element 304S and the position control lever assembly 302 is unlocked from the first locking element 304F, and the extended position (initial position) in which the second locking element 304S and the position control lever assembly 302 is locked with the first locking element 304F at least one of the plurality of locking positions. The resilient member 304R is adapted to move the second locking element 304S from the unlocked position to the locked position in which the position control lever assembly 302 is locked with the first locking element 304F at at least one of the plurality of locking positions on dis-engagement of the hand operated control lever. The resilient member 304R is at least a spring. It is within the scope of the invention to provide any number of resilient means and any other type of resilient means or other elastomeric means or any means to be loaded between the supporting portion 304Sr of the second locking element 304S and the position control lever support member 302T of the position control lever assembly 302 to enable slidable movement of the second locking element 304S with position control lever 302L between the unlocked position and the locked position.

In another embodiment, the locking member position control mechanism (not shown) is at least one of a telescopic arrangement, a hydraulic actuator, a pneumatic actuator, an electric solenoid with plunger and spring arrangement, a telescopic cylinder mechanism, an electric motor with an extendable and retractable shaft, a leadscrew arrangement, a ball screw arrangement, an electro-hydraulic actuator system, an electro-pneumatic actuator system, an adjustable screw arrangement, a linear actuator, and a linear control mechanism.

The draft control mechanism 400 is used to vary the draft of the implement and to dampen the shock load received by the implement when the implement is being towed by the vehicle in agricultural fields. The draft control mechanism 400 is also called as a top link draft control apparatus which forms as a linkage between the lift arm 306L of the linkage mechanism 306 and the implement mounting structure 50. The draft control mechanism 400 is coupled between the lift arm 306L of the linkage mechanism 306 and the implement mounting structure 50 at a predefined angle. It is also within the scope of the invention to couple the draft control mechanism 400 between the lift arm 306L of the linkage mechanism 306 and the implement mounting structure 50 at any orientation. The implement mounting structure 50 is pivotably connected to the first support structure 50F and the second support structure 50S about a hitch pivot axis Ph. The implement mounting structure 50 is at least a hitch. The first support structure 50F and the second support structure 50S are spaced away from each other.

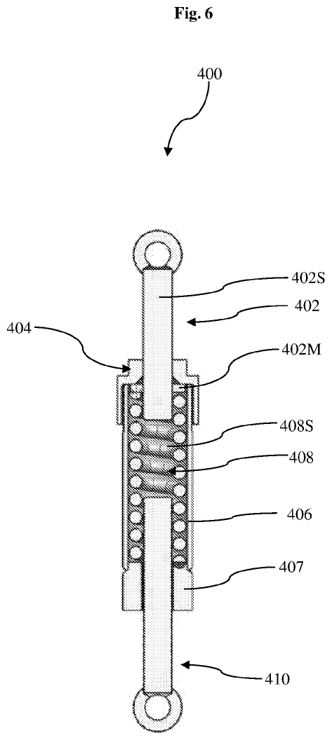

The sliding assembly 402 of the draft control mechanism 400 is coupled to the lift arm 306L of the linkage mechanism 306 to connect the draft control mechanism 400 with the linkage mechanism 306. The sliding assembly 402 is slidably engaged with the first end cover 404 and supports corresponding end of at least one resilient and shock absorber arrangement 408. The sliding assembly 402 is adapted to be at least partially and slidably received inside the housing 406, where one end of the sliding assembly 402 is adapted to be coupled to the lift arm 306L of the linkage mechanism 306. In an embodiment, the sliding assembly 402 includes at least one sliding member 402S (as shown in FIG. 5 and FIG. 6) and at least one support member 402M (as shown in FIG. 5 and FIG. 6). The sliding assembly 402 is adapted to be at least partially and slidably connected to the first end cover 404. For the purpose of this description and ease of understanding, the sliding member 402S of the sliding assembly 402 is coupled with the lift arm 306L of the linkage mechanism 306, and at least partially and slidably connected to the first end cover 404. The sliding member 402S of the sliding assembly 402 is at least a sliding tie rod. It is also within the scope of the invention to provide the sliding member 402S in form of a sliding tie tube. The support member 402M of the sliding assembly 402 is adapted to be connected to the sliding element 402S to support corresponding end of the resilient and shock absorber arrangement 408. The support member 402M of the sliding assembly 402 is also called as a resilient and shock absorber support member or spring support member. The sliding movement of the sliding member 402S with the first end cover 404 enables the support member 402M of the sliding assembly 402 to compress corresponding at least one resilient and shock absorber arrangement 408 which in turn dampens a shock load received by the implement.

In another embodiment, the sliding assembly (402) is an adjustable sliding assembly (402) which comprises a rotatable center member (not shown), at least one adjustable member (not shown), at least one adjustable sliding member (not shown) and at least one support member (not shown). The rotatable center member (not shown) is between the adjustable member (not shown) and the adjustable sliding member (not shown) of the adjustable sliding assembly (402). The adjustable member (not shown) of the adjustable sliding assembly (402) is adapted to be coupled to the lift arm (306L) of the linkage mechanism (306) and at least partially and movably connected to the rotatable center member (not shown) of the adjustable sliding assembly (402). The adjustable sliding member (not shown) of the adjustable sliding assembly (402) is adapted to be at least partially and movably connected to the rotatable center member (not shown), and at least partially and slidably connected to the first end cover (404). The adjustable sliding member (not shown) is opposite to the adjustable member (not shown) of the adjustable sliding assembly (402). The support member (not shown) of the adjustable sliding assembly (402) is adapted to be connected to the adjustable sliding member (not shown) to support corresponding end of the resilient and shock absorber arrangement (408). To vary the draft of the implement, the rotatable center member (not shown) is configured to be moved to move the adjustable member (not shown) and the adjustable sliding member (not shown) with respect to the rotatable center member (not shown) to vary the draft of the implement. The adjustable sliding assembly (402) includes at least one locking element (not shown) for locking the position of the adjustable member (not shown) and the adjustable sliding member (not shown) at corresponding adjusted positions (adjusted length) to lock the adjustable sliding assembly (402) at corresponding position (adjusted length), where the locking element (not shown) is at least one of a threaded nut, a threaded ring, a threaded fastener, a threaded insert, a locking pin and a combination of the above. The sliding movement of the adjustable sliding member (not shown) of the adjustable sliding assembly (402) with the first end cover (404) enables corresponding at least one support member (not shown) of the adjustable sliding assembly (402) to compress corresponding at least one resilient and shock absorber arrangement (408) which in turn dampens the shock load received by the implement. In an embodiment, the rotatable center member (not shown) of the adjustable sliding assembly (402) is at least one of a rotatable center outer tube and a rotatable center outer rod, and correspondingly the adjustable member (not shown) is at least one of an adjustable inner tie rod and an adjustable inner tie tube, and the adjustable sliding member (not shown) is at least one of an adjustable inner sliding rod and an adjustable sliding inner tube. In another embodiment, the rotatable center member of the adjustable sliding assembly (402) is at least one of a rotatable center inner tube and a rotatable center inner rod, and correspondingly the adjustable member (not shown) is at least one of an adjustable outer tie rod and an adjustable outer tie tube, and the adjustable sliding member (not shown) is at least one of an adjustable outer sliding rod and an adjustable sliding outer tube.

In another embodiment, the sliding assembly (402) is an adjustable sliding assembly (402) which comprises a threaded tie member (not shown), at least one adjustable sliding member (not shown) and at least one support member (not shown). The threaded tie member (not shown) of the adjustable sliding assembly (402) is adapted to be coupled to the lift arm (306L) of the linkage mechanism (306). The adjustable sliding member (not shown) of the adjustable sliding assembly (402) is adapted to be at least partially and movably connected to the threaded tie member (not shown) of the adjustable sliding assembly (402), and at least partially and slidably connected to the first end cover (404). The support member (not shown) of the adjustable sliding assembly (402) is adapted to be connected to the adjustable sliding member (not shown) of the adjustable sliding assembly (402) to support corresponding end of the resilient and shock absorber arrangement (408). To vary the draft of the implement, the adjustable sliding member (not shown) of the adjustable sliding assembly (402) is adapted to be moved with respect to the threaded tie member (not shown) of the adjustable sliding assembly (402) to vary the draft of the implement. The adjustable sliding assembly (402) includes at least one locking element (not shown) for locking the position of the adjustable sliding member (not shown) at the adjusted position (adjusted length) to lock the position of the adjustable sliding assembly (402) at corresponding adjusted position (adjusted length), where the locking element (not shown) is at least one of a threaded nut, a threaded ring, a threaded fastener, a threaded insert, a locking pin and a combination of the above. The sliding movement of the adjustable sliding member (not shown) of the adjustable sliding assembly (402) with the first end cover (404) enables corresponding at least one support member of adjustable sliding assembly (402) to compress at least one resilient and shock absorber arrangement (408) which in turn dampens the shock load received by the implement. In one embodiment, the threaded tie member of the adjustable sliding assembly (402) is at least one of a threaded outer tie rod and a threaded outer tie tube and correspondingly the adjustable sliding member (not shown) of the adjustable sliding assembly (402) is at least one of an adjustable inner sliding rod and an adjustable inner sliding tube. In another embodiment, the threaded tie member of the adjustable sliding assembly (402) is at least one of a threaded inner tie rod and a threaded inner tie tube and correspondingly the adjustable sliding member of adjustable sliding assembly (402) is at least one of an adjustable outer sliding rod and an adjustable outer sliding tube.

In another embodiment, the sliding assembly (402) is at least one of an adjustable and slidable telescopic arrangement, a sliding extendable and retractable arrangement, a slidable and adjustable screw arrangement, a slidable and adjustable arrangement, a slidable linear actuator, a slidable linear adjustable arrangement and a slidable telescopic cylinder arrangement.

The first end cover 404 is used to cover a top side of the housing 406 and to enable a sliding movement of the sliding assembly 402 with respect to the first end cover 404. The first end cover 404 is connected to the housing 406. For the purpose of this description and ease of understanding, the first end cover 404 defines a housing receiving portion (not shown) and a sliding member receiving portion (not shown). The housing receiving portion (not shown) of the first end cover 404 is used to receive a portion of the housing 406 therein to connect the first end cover 404 with the housing 406. In another embodiment, at least a portion of the first end cover 404 can be received by corresponding portion of the housing 406 to connect the first end cover 404 to the housing 406. The sliding member receiving portion (not shown) of the first end cover 404 is used to receive corresponding portion of the sliding member 402S of the sliding assembly 402 to enable sliding movement of the sliding member 402S of the sliding assembly (402) with respect to the end cover 404. The sliding member receiving portion (not shown) of the end cover 404 is at least an opening which is provided at a center of the first end cover 404. The first end cover 404 is a top end cover.

The housing 406 is used to accommodate at least one resilient and shock absorber arrangement 408. The housing 406 is between the first end cover 404 and the second end cover 407. In an embodiment, the housing 406 is configured to be moved with respect to at least one of the first end cover 404 and the second end cover 407 to vary the draft of the implement. The housing 406 has circular cross-section. It is also within the scope of the invention to provide the housing 406 with any other cross-section. The housing 406 is a tubular cylindrical housing. It is also within the scope of the invention to provide the housing (406) as a split housing in which the housing (406) is split into two portions.

The second end cover 407 is used to cover a bottom side of the housing 406 and to enable adjustable movement of the adjustable assembly (410) with respect to the second end cover 407. The second end cover 407 is connected to the housing 406 and disposed opposite to the first end cover 404. For the purpose of this description and ease of understanding, the second end cover 407 defines a support portion (not shown) and an adjustable member receiving portion (not shown). The support portion (not shown) of the second end cover 407 is disposed inside the housing 406. The support portion (not shown) of the second end cover 407 is used to support corresponding another end of at least one resilient and shock absorber arrangement 408. The adjustable member receiving portion (not shown) of the second end cover 407 is used to receive corresponding portion of an adjustable member 410A of the adjustable assembly 410. The adjustable member receiving portion (not shown) of the second end cover 407 is provided with threads. At least one of the first end cover 404 and the second end cover 407 is configured to be moved with respect to the housing 406 to vary the draft of the implement.

The resilient and shock absorber arrangement 408 is used to dampen a shock load received by the implement. The resilient and shock absorber arrangement 408 is adapted to be provided between the sliding assembly 402, and at least one of the second end cover 407 and the adjustable assembly (410), where the resilient and shock absorber arrangement 408 is disposed inside the housing 406. For the purpose of this description an ease of understanding, the resilient and shock absorber arrangement 408 comprises at least one resilient and shock absorber element 408S (as shown in FIG. 6) adapted to be provided inside the housing 406 and loaded between the support member 402M of the sliding assembly 402 and the support portion (not shown) of the second end cover 407. The resilient and shock absorber arrangement 408 is movable between an extended position (initial position) and a compressed position or retracted position to dampen the shock load received by the implement. The resilient and shock absorber element 408S is at least one of a coil spring, a disc spring stack and an elastomer spring. It is also within the scope of the invention to provide any other type of shock absorbing means for absorbing the shock load received by the implement.

In another embodiment, the resilient and shock absorber arrangement (408) includes at least one first resilient and shock absorber element (not shown) and at least one second resilient and shock absorber element (not shown). The first resilient and shock absorber element (not shown) defines one part of the resilient and shock absorber arrangement (408), and the second resilient and shock absorber element (not shown) defines another part of the resilient and shock absorber arrangement (408). In one embodiment, the first resilient and shock absorber element (not shown) is adapted to be provided inside the housing (406) and loaded between the second resilient and shock absorber element, and at least one of the second end cover (407) and the adjustable assembly (410), where the second resilient and shock absorber element (not shown) is adapted to be concentrically loaded onto the first resilient and shock absorber element between the sliding assembly (402). In another embodiment, the first resilient and shock absorber element (not shown) is adapted to be provided inside the housing (406) and loaded between the sliding assembly (402) and at least one of the second end cover (407) and the adjustable assembly (410), where the second resilient and shock absorber element (not shown) is adapted to be concentrically provided inside the first resilient and shock absorber element (not shown), and loaded between the sliding assembly (402) and at least one of the second end cover (407) and the adjustable assembly (410). In another embodiment, the first resilient and shock absorber element (not shown) is adapted to be provided inside the housing (406) and loaded between the sliding assembly (402) and at least one of the second end cover (407) and the adjustable assembly (410), where the second resilient and shock absorber element (not shown) is adapted to be provided parallel to the first resilient and shock absorber element, and loaded between the sliding assembly (402) and at least one of the second end cover (407) and the adjustable assembly (410). In an embodiment, the first resilient and shock absorber element (not shown) is at least one of a coil spring, a disc spring stack and an elastomer spring. In an embodiment, the second resilient and shock absorber element is at least one of a coil spring, a disc spring stack and an elastomer spring.

In another embodiment, the resilient and shock absorber arrangement (408) includes at least one central resilient and shock absorber arrangement (not shown) and a plurality of peripheral resilient and shock absorber elements (not shown). The central resilient and shock absorber arrangement (not shown) is adapted to be provided inside the housing (406) and loaded between the sliding assembly (402), and at least one of the second end cover (407) and the adjustable assembly (410). The plurality of peripheral resilient and shock absorber elements are adapted to be provided outside the central resilient and shock absorber arrangement and loaded between the sliding assembly (402), and at least one of the second end cover (407) and the adjustable assembly (410). Each peripheral resilient and shock absorber element (not shown) is at least one of a coil spring, a disc spring stack and an elastomer spring. It is also within the scope of the invention to provide the resilient and shock absorber arrangement (408) with any other types of shock absorbing means for dampening the shock load received by the implement.

The adjustable assembly 410 is coupled with the implement mounting structure 50, and movably connected with the second end cover 407 to vary the draft of the implement. The adjustable assembly 410 is adapted to be at least partially received inside the housing 406 and disposed opposite to the sliding assembly 402. For the purpose of this description and ease of understanding, the adjustable assembly 410 is adapted to be at least partially and movably connected to the second end cover 407, where one end of the adjustable assembly 410 is adapted to be coupled to the implement mounting structure 50. At least one of the adjustable assembly 410 and the sliding assembly (402) is configured to be moved with respect to the housing 406 to vary the draft of the implement. In an embodiment, the adjustable assembly 410 includes at least one adjustable member 410A (as shown in FIG. 5 and FIG. 6). The adjustable member 410A of the adjustable assembly (410) is coupled with the implement mounting structure 50), and movably connected with the adjustable member receiving portion (not shown) of the second end cover 407. A portion of the adjustable member 410A is provided with a plurality of external threads. To adjust the draft of the implement, the adjustable member 410A is moved with respect to the second end cover 407 to vary the draft of the implement. The adjustable member 410A is at least one of a threaded tie rod and a threaded tie tube. The adjustable assembly 410 includes at least one locking element for locking the position of the adjustable member (410A) at the adjusted position (adjusted length), where the locking element (not shown) is at least one of a threaded nut (not shown), a threaded ring (not shown), a threaded fastener, a threaded insert (not shown), a locking pin (not shown) and a combination of the above. In another embodiment, the adjustable assembly (410) includes at least one support member (not shown) adapted to be connected to the adjustable member (410A), where the support member (not shown) is used to support corresponding another end of at least one resilient and shock absorber arrangement (408).

In another embodiment, the adjustable assembly (410) comprises a rotatable center member (not shown) and a plurality of adjustable members (not shown). The plurality of adjustable members comprises at least one first adjustable member (not shown) and at least one second adjustable member (not shown). The first adjustable member (not shown) is adapted to be coupled to the implement mounting structure (50) and at least partially and movably connected to the rotatable center member (not shown) of the adjustable assembly (410). The second adjustable member (not shown) is adapted to be at least partially and movably connected to the rotatable center member (not shown) and the second end cover (407). The second adjustable member (not shown) is opposite to the first adjustable member (not shown) of the adjustable assembly (410). To adjust the draft of the implement, the rotatable center member (not sown) is configured to be moved to move the first adjustable member (not shown) and the second adjustable member (not shown) with respect to the rotatable center member (not shown) to vary the draft of the implement. The adjustable assembly (410) includes a plurality of locking elements (not shown) for locking the position of the first adjustable member (not shown) and the second adjustable member (not shown) at corresponding adjusted positions (adjusted length) to lock the adjustable assembly (410) at corresponding position (adjusted length), where the locking element (not shown) is at least one of a threaded nut, a threaded ring, a threaded fastener, a threaded insert, a locking pin and a combination of the above. In another embodiment, the adjustable assembly (410) comprises at least one support member (not shown) adapted to be connected to the second adjustable member (not shown) of the adjustable assembly (410) at corresponding predetermined position. The support member of the adjustable assembly (410) is used to support the corresponding another end of at least one resilient and shock absorber arrangement (408). In an embodiment, the rotatable center member of the adjustable assembly (410) is at least one of a rotatable center outer tube and a rotatable center outer rod, and correspondingly the first adjustable member (not shown) of the adjustable assembly (410) is at least one of an adjustable inner tie rod and an adjustable inner tie tube, and the second adjustable member of the adjustable assembly (410) is at least one of an adjustable inner rod and an adjustable inner tube. In another embodiment, the rotatable center member of the adjustable assembly (410) is at least one of a rotatable center inner tube and a rotatable center inner rod, and correspondingly the first adjustable member (not shown) of the adjustable assembly (410) is at least one of an adjustable outer tie rod and an adjustable outer tie tube, and the second adjustable member (not shown) of the adjustable assembly (410) is at least one of an adjustable outer rod and an adjustable outer tube.

In another embodiment, the adjustable assembly (410) comprises a threaded tie member (not shown) and at least one adjustable member (not shown). The threaded tie member (not shown) of the adjustable assembly (410) is coupled with the implement mounting structure (50). The adjustable member (not shown) of the adjustable assembly (410) is adapted to be at least partially and movably connected to the threaded tie member (not shown) and the second end cover (407). To adjust the draft of the implement, adjustable member (not shown) of the adjustable assembly (410) is configured to be moved with respect to the threaded tie member (not shown) of the adjustable assembly (410) to vary the draft of the implement. The adjustable assembly (410) includes at least one locking element (not shown) for locking the position of the adjustable member (not shown) at corresponding adjusted position (adjusted length) to lock the adjustable assembly (410) at corresponding position (adjusted length), where the locking element (not shown) is at least one of a threaded nut, a threaded ring, a threaded fastener, a threaded insert, a locking pin and a combination of the above. In another embodiment, the adjustable assembly (410) includes at least one support member (not shown) adapted to be connected to the adjustable member (not shown) of the adjustable assembly (410). The support member (not shown) of the adjustable assembly (410) is adapted to support corresponding another end of the resilient and shock absorber arrangement (408). In an embodiment, the threaded tie member (not shown) of the adjustable assembly (410) is at least one of a threaded outer tie rod and a threaded outer tie tube and correspondingly the adjustable member (not shown) of the adjustable assembly (410) is at least one of an adjustable inner rod and an adjustable inner tube. In another embodiment, the threaded tie member of the adjustable assembly (410) is at least one of a threaded inner tie rod and a threaded inner tie tube, and correspondingly the adjustable member (not shown) of the adjustable assembly (410) is at least one of an adjustable outer rod and an adjustable outer tube.

In another embodiment, the adjustable assembly (410) is at least one a telescopic adjustable arrangement, an adjustable extendable and retractable arrangement, an adjustable screw arrangement, an adjustable linear actuator, and a linear adjustable arrangement.

For the purpose of this description and ease of understanding, the working of the position and draft control mechanism 30 according to corresponding embodiment is as follows. When there is requirement to change the position of the implement, the operator (engages the position control lever 302L to engage the hand operated control lever (not shown) which pulls the cable (not shown) of the hand operated locking member position control mechanism (not shown) and the cable (not shown) pulls the arm 304Sa of the second locking element 302S in a downward direction to move the second locking element 304S from the locked position to the unlocked position in which the locking portion 304Sp of the second locking element 304S is disengaged from corresponding locking portion 304Fp of the first portion 304Fa of the first locking element 304F and the supporting portion 304Sr of the second locking element 304S is disengaged from the bottom portion of the first portion 304Fa of the first locking element 304F to unlock the second locking element 304S and position control lever assembly 302 from the first locking element 304F. Thereafter, when the operator angularly moves the position control lever 302L of the position control lever assembly 302 to position the position control lever assembly 302 at least one of a plurality of positions, the arm 302Ta of the position control lever support member 302T is adapted to at least one of pull and push the linkage element 306Sb of the cross-shaft assembly 306S through the coupler 306C to move the cross-shaft 306Sa which in turn moves the lift arm 306L, and the lift arm 306L moves the implement mounting structure 50 through the draft control mechanism 400 to position the implement at corresponding least one of the plurality of positions. Thereafter, the operator dis-engages the hand operated control lever which pushes cable (not shown) of the locking member position control mechanism (not shown), and the cable (not shown) releases the cable pulling force on the second locking element 304S and the resilient member 304R moves from the compressed position (retracted position) to the extended position (initial position) to move the second locking element 304S from the unlocked position to the locked position in which the locking portion 304Sp of the second locking element 304S is engaged with corresponding at least one locking portion 304Fp of the first portion 304Fa of the first locking element 304F and the supporting portion 304Sr of the second locking element 304S is engaged with the bottom portion of the first portion 304Fa of the first locking element 304F at corresponding at least one locking position (locking point) to lock the second locking element 304S and the position control lever assembly 302 with the first locking element 304F at corresponding at least one position thereby locking the implement corresponding at least one position.

Now, when there is a requirement to vary the draft of the implement, the operator moves the adjustable member 410A of the adjustable assembly 410 with respect to the second end cover 407 to change the position of the adjustable member 410A therein to vary the draft of the implement to regulate corresponding depth operation of the implement.

Therefore, a position and draft control mechanism 30 for controlling the position (raising and lowering) of an agricultural implement, and to vary the draft of the implement, and to dampen a shock load received by the implement when the implement is being towed by a vehicle in agricultural fields is provided.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A position and draft control mechanism 30 for controlling the position and draft of an implement coupled to an implement mounting structure 50 of a vehicle, said mechanism 30 comprising:
a position control lever assembly 302 adapted to be pivotably connected to a first support structure 50F;
a locking arrangement 304 adapted to lock said position control lever assembly 302 at at least one of a plurality of positions; and
a linkage mechanism 306 adapted to couple said position control lever assembly 302 with the implement mounting structure 50 through a draft control mechanism 400,
wherein
a movement of said position control lever assembly 302 induces a change in the position of the implement; and
said draft control mechanism 400 is adapted to vary the draft of the implement.

2. The mechanism 30 as claimed in claim 1, wherein said position control lever assembly 302 comprises,
a position control lever support member 302T adapted to be pivotably connected to the first support structure 50F; and
a position control lever 302L adapted to be supported by said position control lever support member 302T.

3. The mechanism 30 as claimed in claim 2, wherein said linkage mechanism 306 comprises, a cross-shaft assembly 306S comprising a cross-shaft 306Sa and a linkage element 306Sb adapted to be connected to said cross-shaft 306Sa;
a coupler 306C adapted to be coupled between said position control lever support member 302T of said position control lever assembly 302 and said linkage element 306Sb of said cross-shaft assembly 306S; and
a lift arm 306L adapted to be movably connected to said cross-shaft 306Sa of said cross-shaft assembly 306 and coupled with the implement mounting structure 50 through said draft control mechanism 400.

4. The mechanism 30 as claimed in claim 3, wherein said locking arrangement 304 comprises,
a first locking element 304F; and
a second locking element 304S adapted to be movably engaged with said first locking element 304F and said position control lever assembly 302, wherein
said second locking element 304S is movable between an unlocked position in which said position control lever assembly 302 is unlocked from said first locking element 304F, and a locked position in which said position control lever assembly 302 is locked with said first locking element 304F at at least one of a plurality of locking positions.

5. The mechanism 30 as claimed in claim 4, wherein said first locking element 304F has a first portion 304Fa defining a slot 304Fs, and a plurality of locking portions 304Fp provided in the slot 304Fs at corresponding locking positions,
said second locking element 304S has at least one locking portion 304Sp corresponding to the locking portion 304Fp of the first portion 304Fa of said first locking element 304.

6. The mechanism 30 as claimed in claim 5, wherein the locking portion 304Sp of said second locking element 304S is disengaged from corresponding at least one locking portion 304Fp of said first locking element 304F to unlock said position control lever assembly 302 from said first locking element 304F on movement of said second locking element 304S to the unlocked position.

7. The mechanism 30 as claimed in claim 6, wherein the locking portion 304Sp of said second locking element 304S is engaged with at least one of the plurality of locking portions 304Fp of the first portion 304Fa of said first locking element 304F to lock said position control lever assembly 302 to said first locking element 304F at corresponding at least one of the plurality of locking positions on movement of said second locking element 304S to the locked position.

8. The mechanism 30 as claimed in claim 7 comprises a locking member position control mechanism adapted to control the movement of said second locking element 304S between the unlocked position and the locked position.

9. The mechanism 30 as claimed in claim 8, wherein said locking member position control mechanism is a hand operated locking member position control mechanism comprising, a hand operated control lever adapted to be connected to said position control lever 302L of said position control lever assembly 302; and
a cable, where one end of said cable is connected to said hand operated control lever and another end of said cable is connected to said second locking element 304S of said locking arrangement 304,
wherein
said cable is adapted to move said second locking element 304S from the locked position to the unlocked position on engagement of said hand operated control lever.

10. The mechanism 30 as claimed in claim 9 comprises at least one resilient member 304R adapted to be loaded between said second locking element 304S and said position control lever support member 302T of said position control lever assembly 302, wherein
said resilient member 304R is adapted to move said second locking element 304S from the unlocked position to the locked position in which said position control lever assembly 302 is locked with said first locking element 304F at at least one of the plurality of locking positions on dis-engagement of said hand operated control lever.

11. The mechanism 30 as claimed in claim 8, wherein said locking member position control mechanism is at least one of a telescopic arrangement, a hydraulic actuator, a pneumatic actuator, an electric solenoid with plunger and spring arrangement, a telescopic cylinder mechanism, an electric motor with an extendable and retractable shaft, a leadscrew arrangement, a ball screw arrangement, an electro-hydraulic actuator system, an electro-pneumatic actuator system, an adjustable screw arrangement, a linear actuator, and a linear control mechanism.

12. The mechanism 30 as claimed in claim 3, wherein said draft control mechanism 400 is adapted to be coupled between said lift arm 306L of said linkage mechanism 306 and the implement mounting structure 50 at a predefined angle.

13. The mechanism 30 as claimed in claim 12, wherein said draft control mechanism 400 comprises,
at least one housing 406;
at least one sliding assembly 402 adapted to be at least partially and slidably received inside said housing 406; and
at least one adjustable assembly 410 adapted to be at least partially received inside said housing 406 and disposed opposite to said sliding assembly 402, wherein
at least one of said adjustable assembly 410 and said sliding assembly (402) is configured to be moved with respect to said housing 406 to vary the draft of the implement.

14. The mechanism 30 as claimed in claim 13, wherein said draft control mechanism 400 comprises,
at least one resilient and shock absorber arrangement 408 adapted to dampen a shock load received by the implement.

15. The mechanism 30 as claimed in claim 14, wherein said draft control mechanism 400 comprises,
a first end cover 404 adapted to be connected to said housing 406; and
a second end cover 407 adapted to connected to said housing 406 and disposed opposite to said first end cover 404.

16. The mechanism 30 as claimed in claim 15, wherein said resilient and shock absorber arrangement 408 is adapted to be provided between said sliding assembly 402, and at least one of said second end cover 407 and said adjustable assembly (410).

17. The mechanism 30 as claimed in claim 16, wherein said sliding assembly 402 is adapted to be at least partially and slidably connected to said first end cover 404, wherein
one end of said sliding assembly 402 is adapted to be coupled to said lift arm 306L of said linkage mechanism 306.

18. The mechanism 30 as claimed in claim 17, wherein said adjustable assembly 410 is adapted to be at least partially and movably connected to said second end cover 407, wherein
one end of said adjustable assembly 410 is adapted to be coupled to the implement mounting structure 50.

19. The mechanism 30 as claimed in claim 18, wherein at least one of said first end cover 404 and said second end cover 407 is configured to be moved with respect to said housing 406 to vary the draft of the implement.

20. The mechanism 30 as claimed in claim 15, wherein said housing 406 is configured to be moved with respect to at least one of said first end cover 404 and said second end cover 407 to vary the draft of the implement.

21. The mechanism 30 as claimed in claim 17, wherein said sliding assembly 402 comprises,
at least one sliding element 402S adapted to be connected to said lift arm 306L of said linkage mechanism, and at least partially and slidably connected to said first end cover 404; and
at least one support member 402M adapted to be connected to said sliding element 402S to support corresponding end of said resilient and shock absorber arrangement 408.

22. The mechanism 30 as claimed in claim 21, wherein said resilient and shock absorber arrangement 408 comprises at least one resilient and shock absorber element 408S adapted to be provided inside said housing 406, and loaded between said support member 402M of said sliding assembly 402 and said second end cover 407.

23. The mechanism 30 as claimed in claim 18, wherein said adjustable assembly 410 comprises,
at least one adjustable member 410A adapted to be coupled to the implement mounting structure 50, and at least partially and movably connected to said second end cover 407,
wherein said adjustable member 410A is adapted to be moved with respect to said second end cover 407 to vary the draft of the implement.

24. The mechanism 30 as claimed in claim 17, wherein said sliding assembly 402 is an adjustable sliding assembly (402) comprising,
a rotatable center member;
at least one adjustable member adapted to be coupled to said lift arm (306L) of said linkage mechanism (306) and at least partially and movably connected to said rotatable center member;
at least one adjustable sliding member adapted to be at least partially and movably connected to said rotatable center member, and at least partially and slidably connected to said first end cover (404); and
at least one support member adapted to be provided inside said housing (406) and connected to said adjustable sliding member to support corresponding end of said resilient and shock absorber arrangement (408),
wherein
said rotatable center member is configured to be moved to move said adjustable member and said adjustable sliding member with respect to said rotatable center member to vary the draft of the implement.

25. The mechanism 30 as claimed in claim 17, wherein said sliding assembly 402 is an adjustable sliding assembly (402) comprising,
a threaded tie member adapted to be coupled to said lift arm (306L) of said linkage mechanism (306),
at least one adjustable sliding member adapted to be at least partially and movably connected to said threaded tie member, and at least partially and slidably connected to said first end cover (404); and
at least one support member adapted to be connected to said adjustable sliding member to support corresponding end of said resilient and shock absorber arrangement (408), wherein
said adjustable sliding member is adapted to be moved with respect to said threaded tie member to vary the draft of the implement.

26. The mechanism 30 as claimed in claim 17, wherein said sliding assembly (402) is at least one of an adjustable and slidable telescopic arrangement, a sliding extendable and retractable arrangement, a slidable and adjustable screw arrangement, a slidable and adjustable arrangement, a slidable linear actuator, a slidable linear adjustable arrangement and a slidable telescopic cylinder arrangement.

27. The mechanism 30 as claimed in claim 18, wherein said adjustable assembly (410) comprises,
a rotatable center member; and
a plurality of adjustable members comprising at least one first adjustable member adapted to be coupled to the implement mounting structure (50) and at least partially and movably connected to said rotatable center member, and at least one second adjustable member adapted to be at least partially and movably connected to said rotatable center member and said second end cover (407),
wherein
said rotatable center member is configured to be moved to move said first adjustable member and said second adjustable member with respect to said rotatable center member to vary the draft of the implement.

28. The mechanism 30 as claimed in claim 18, wherein said adjustable assembly (410) comprises,
a threaded tie member adapted to be coupled to the implement mounting structure (50); and
at least one adjustable member adapted to be at least partially and movably connected to said threaded tie member and said second end cover (407), wherein
said adjustable member is configured to be moved with respect to said threaded tie member to vary the draft of the implement.

29. The mechanism 30 as claimed in claim 18, wherein said adjustable assembly (410) is at least one of a telescopic adjustable arrangement, an adjustable extendable and retractable arrangement, an adjustable screw arrangement, an adjustable linear actuator, and a linear adjustable arrangement.
